(19) United States
(12) Patent Application Publication
(10) Pub. No.: US 2012/0042182 A1
(43) Pub. Date: Feb. 16, 2012

(54) FORCED IDLE CACHE

(75) Inventors: Christopher Fulkerson, Longmont, CO (US); Abhay Kataria, Longmont, CO (US); Bradley Gill, Longmont, CO (US)

(73) Assignee: Seagate Technology LLC, Scotts Valley, CA (US)

(21) Appl. No.: 12/853,452

(22) Filed: Aug. 10, 2010

(51) Int. Cl. G06F 1/32; G06F 12/08; G06F 12/00

(52) U.S. Cl. 713/320; 711/135; 711/E12.001; 711/E12.022

(57) ABSTRACT

An interface controller of an electronic device manages power consumption of the electronic device by caching data associated with write commands received while the electronic device is in an idle mode. In one implementation, an interface controller directs write commands to a write cache until disc access is required. Additionally, the interface controller may direct write commands to the write cache until the write cache becomes full or a non-cached read command is received. Once, disc access is required, the data associated with the cached commands are flushed to the hard disc. In one implementation, the interface controller transitions the electronic device to a lower power state and maintains the electronic device in the lower power state until disc access is required. When disc access is required, the interface controller transitions the electronic device to a higher power state.

### BACKGROUND

Storage device power is the aggregate of power of various operating modes. While read, write, and seek modes of a storage device consume the most power, various idle modes consume significantly less power. By reducing the overall power consumption of a storage device, battery life may be improved. Further, reducing power consumption reduces heat output, which may allow for the removal of fans, resulting in reduced noise and cost. Additionally, lower power drives may also permit the use of smaller hard storage device controllers.

### SUMMARY

Implementations described and claimed herein reduce the consumption of power in a storage device by caching data associated with write commands received while the storage device is in an idle mode

Other implementations are also described and recited herein.

### BRIEF DESCRIPTIONS OF THE DRAWINGS

FIG. 1 illustrates an example of a computing system incorporating a storage device having a cache.

FIG. 2 illustrates an example power utilization profile for a storage device.

FIG. 3 illustrates example operations for forcing an idle cache.

FIG. 4 illustrates an example power utilization profile for a storage device that does not utilize a forced idle cache.

FIG. 5 illustrates an example power utilization profile for a storage device utilizing a forced idle cache.

FIG. 6A illustrates example operations for forcing an idle cache.

FIG. 6B illustrates example operations for forcing an idle cache.

FIG. 6C illustrates example operations for forcing an idle cache.

FIG. 7 illustrates example storage device operation modes for conservation of power.

### DETAILED DESCRIPTIONS

Storage devices, such as hard disk drives (HDD) and solid state drives (SSD), exist in computers in order to store information such as the operating system used by the computer, software applications and their data, emails, media, amongst other data. Information is constantly read from and written to a storage device. When a storage device receives a request to write information to the storage medium, the storage device determines where the information is to be physically stored on the medium. In the case of a hard disc drive, when the storage device determines a suitable location to store the data, a read/write transducer is moved, by an actuator, to the physical location on the storage medium where the information will be written. The time 1) to determine a location to store the information and 2) move the transducer to the desired location (e.g., seek time) may take up to 10 milliseconds (ms). Computer performance may be drastically affected if the computer has to wait up to 10 ms for each write request that occurs during normal computing. Additionally, when the computer requests to receive existing information from the storage device, through a read request, a comparable amount of time is spent moving the read/write transducer to the physical location where the requested data is stored.

Accordingly, storage devices are equipped with read and write caches to address the problem of reduced performance during a seek or a read/write operation. In one implementation, a cache or a buffer is a temporary storage medium, embedded into the storage device, where data can be temporarily stored. In the case of a write cache, data may be temporarily stored in the write cache before being written to the storage medium. In the case of a read cache, frequently accessed data may be stored in the read cache as a means of reducing the time for accessing this data without accessing the storage medium. A cache may be comprised of random access memory (RAM) such as direct random access memory (DRAM), or static random access memory (SRAM). Reading data from and writing data to RAM is significantly faster than reading data from and writing data to a traditional platter-based hard disc drive. However, RAM is a volatile memory, which means that the memory needs a constant power source to maintain the data stored therein. In other words, once the computer is turned off, or loses power, the storage device's read and write caches are erased. Additionally, RAM may be cost-prohibitive as a storage solution for storage drives, as the cost per gigabyte of RAM is significantly higher than the equivalent cost for hard disc drives, which have eclipsed two terabytes in size. In one implementation, the total size of a storage device cache is between 16 and 32 megabytes (MB) with sizes as high as 128 MB. In one implementation, the write cache and the read cache may equally split the total size of the cache. However, the delineation between the read and write cache may be dynamically altered.

When a storage device utilizes a write cache, data from a write request may be written to the write cache before being persistently written to the storage medium. Writing data to the write cache does not have the same delays as writing data to the hard disk. Once data has been written to the write cache, the computer connected to the storage device does not need to wait for the data to be persistently written to the storage medium. In one implementation, the computer may be unaware that the data still resides in the write cache, and has not yet been persistently written to the storage medium. At a later time, the data can be moved from the write cache (e.g., flushed from the cache) to the storage device's non-volatile storage medium, without degrading performance of the computer. The write cache can be erased once the data is written to the non-volatile storage medium.

Additionally, when a storage device utilizes a read cache, frequently accessed data may be copied from persistent storage in the storage medium to the read cache. When the CPU requests access to data already stored in the read cache, the hard disc does not have to be accessed. As such, response time is improved. Another advantage of reading to and writing from a cache comes from a reduction in the power consumed to retrieve the data from a cache compared to retrieving the data from the storage medium. In other words, the amount of electrical power used to access the read and write cache may be less than the amount of electrical power used to read or write data to/from the hard disc. As such, from a power utilization perspective, it may be beneficial to utilize both the read and write cache as much as possible before accessing the storage medium.

Another advantage to utilizing a storage device's read and write caches is to increase efficiency by postponing access to the storage medium until access is needed. Each time the storage medium is accessed, a temporary spike in power consumption may result. In other words, when the storage device is idle (e.g., no disc access is presently occurring) power consumption may be moderate. When the storage medium is accessed, power consumption increases until the storage device returns to an idle state. If requests to access the storage medium can be temporarily postponed, the storage device can remain in an idle state longer. At a later time, the previously stored requests may be processed in succession while keeping the storage device in a single non-idle state while the requests are processed. As a result, the amount of power consumed by the storage device to process a succession of stored requests is less the power consumed to process each request on-demand.

Another advantage to storing requests and processing them in succession is the ability to reorder the requests to best utilize the storage medium. In other words, when multiple read/write requests are received and stored, there may be a quicker and more efficient manner for processing these requests than in the order in which they were originally received. As such, the time for processing the request and the power consumed may be reduced.

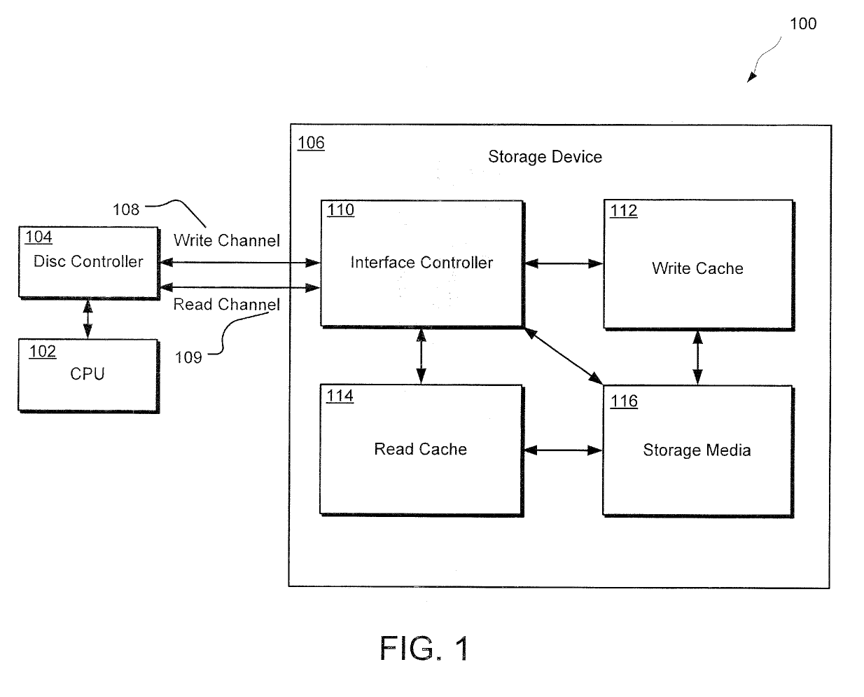

FIG. 1 illustrates an example of a computing system 100 incorporating a storage device having a cache. Computing system 100 may comprise a CPU 102, a disc controller 104, and a storage device 106. The CPU 102 communicates with the storage device 106 in order to write to and access data stored in the storage device 106. The CPU 102 communicates with the storage device 106 through one or more write channels 108 and read channels 109 connected to an interface controller 110 of the storage device 106. In one implementation, the write channels 108 couple to the CPU 102 through the disk controller 104. Differing architectures may exist for permitting the CPU 102 to communicate with the storage device 106.

The storage device 106 comprises of at least an interface controller 110, a write cache 112, a read cache 114, and a storage medium 116. In one implementation, the interface controller 110 is responsible for communicating read and write requests to and from the CPU 102, to the storage device 106. In one implementation, when a write request is sent from the CPU 102 to the storage device 106, the interface controller 110 intercepts the data from the write request and places it in the write cache 112. As previously stated, the write cache 112 temporarily holds data to be written to the storage medium 116 as a means of increasing performance of the computer and to reduce power requirements of the storage device. In other words, since the data can be written to the write cache 112 much faster than the storage medium 116, the CPU 102 does not need to wait for the data to be persistently written to the storage medium 116 before proceeding to other operations. As stated above, the time spent determining a write location on a storage medium, as well as the time spent moving a read/write actuator (e.g., seek time) to the desire location, can be lengthy. If the CPU 102 waits for these steps to occur before proceeding to other operations, performance of the CPU 102 decreases considerably. Additionally, the amount of electrical power used to write data to the write cache 112 may be less than that of writing data to the storage medium 116. In one implementation, the data stored in the write cache 112 is flushed from the write cache 112 once the write cache 112 is full. In one implementation, flushing of the write cache means that the data stored in the write cache 112 is copied to the storage medium 116 and then removed from the write cache 112.

In regards to a read request, accessing data from the read cache 114 also provides benefits. If the data request from the read request exists in the read cache 114, the data may be returned to the CPU 102 faster than if the data was retrieved from the storage medium 116. Additionally, the amount of power used to access the data from the read cache is less than the amount of power used to access the data from the storage medium 116.

One implementation for reducing power requirements is to utilize the read and write caches of the storage device 106 as often as possible. In the case of a write request, the interface controller 110 may purposely delay moving data from the write cache 112 to the storage medium 116 until the write cache 112 is full. As such, data remains in the write cache for as long as possible. In the case of a read request, the interface controller 110 accesses the data from the read cache 114, assuming the requested data exists in the read cache. By delaying reading from and writing to the storage medium 116, a reduction in power consumption may result. By storing the data associated with write commands into the write cache, the interface controller 110 is able to write the data to the storage medium 116 in a single pass instead of writing the data after each request is received. Additionally, the interface controller may reorder stored requests into a more efficient processing order than if the requests were processed in the order in which they were received. This may further result in reduced processing time and power consumption.

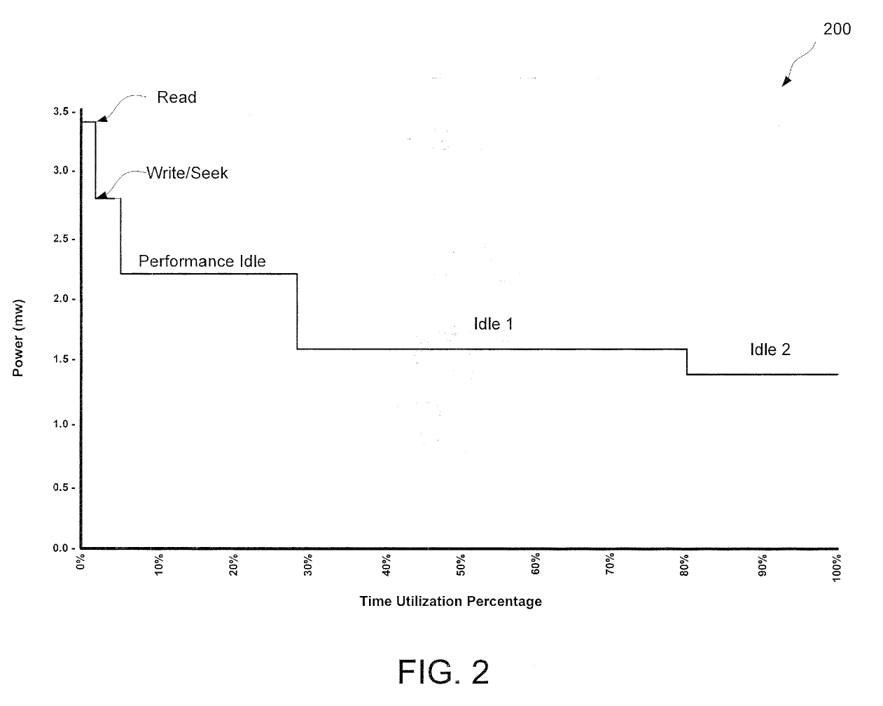

FIG. 2 illustrates an example power utilization profile 200 for a storage device. The power utilization profile 200 shows power, in milliwatts (mw), in the Y-axis and a power utilization percentage in the X-axis. While read commands utilize a small percentage of time utilization in a storage device, read commands consume more power than any other operation. Write commands and seek commands also utilize a relatively small time utilization of a storage device, but they still consume significant amounts of power. In contrast, idle modes, such as Performance Idle, Idle 1, and Idle 2, consume less power than read and write commands. The reason for such changes in power consumption result from read, writes, and seek commands accessing the hard disc. As described above, accessing the hard disc utilizes an actuator to move read/write transducers across the disc surface. Additionally, the reading and writing of information to a hard disc also consumes significant amounts of power. By increasing the time spent in idle modes, and reducing the number of disc accesses, power consumption can be reduced.

In one implementation, different idle modes may exist. As illustrated in FIG. 2, a Performance Idle mode consumes more power than either an Idle 1 mode or an Idle 2 mode. However, as a trade-off for higher power consumption, the hard disc may transition from the Performance Idle mode to an active mode (e.g., accessing the disc) in a shorter amount of time than from Idle 1 or Idle 2 to an active mode. Hence, each of the three idle modes has a trade-off between power consumption and the recovery time for accessing the disc (e.g., spin-up time.) In one implementation, when a hard disc is in a Performance Idle mode some of the electronics used to access the hard disc remain active. As such, there may be insignificant power savings in this mode. However, there is relatively minimal delay in transitioning to an active mode from a Performance Idle mode. In one implementation, the Performance Idle mode is the standard mode of the storage device.

An Idle 1 mode offers a savings in power consumption over the Performance Idle mode at the cost of a delay in spin-up or recovery time. In one implementation, when a storage device enters the Idle 1 mode, the electronic components used to synchronize a track follow loop with the embedded pattern on the discs are powered down. Such components may include the read circuitry, pre-amps, and power regulators. Once the components are shut down, the discs continue to spin at the full revolutions per minute (RPM.). However, the read/write transducers or heads are held fixed to protect them from shock events. In Idle 1 mode, the storage device transitions to consuming the lowest amount of power possible, while still maintaining the discs at full RPMs with the heads maintained in position over the discs. In one implementation, the timeframe for powering up the electronics and transitioning back to an active mode is between 50-60 ms.

An Idle 2 mode offers an additional savings in power consumption over the Idle 1 mode at the cost of additional delay in head load time (i.e., the amount of time taken to reposition the heads over the discs). In one implementation, when the storage device transitions into the Idle 2 mode, the read/write heads are moved from the disc and put up on the ramp. By moving the heads away from the discs, there may be a reduction in windage created by the spinning discs, which decreases the power to maintain the discs at full RPMs. Additionally, the voice coil motor (VCM) circuitry can also be powered down during Idle 2 mode. Moving the heads to the ramp and shutting down the VCM circuitry, provides the storage device with additional shock protection over the Idle 1 mode. In one implementation, the time to transition from Idle 2 to an active mode is 200-500 ms.

An Idle 3 mode may also be implemented wherein the discs' spinning RPMs are reduced or stopped completely. Slowing or stopping the rotation of the discs can offer additional power savings over even the Idle 2 mode. However, the spin-up time may increase as well. It is noted, that a differing number of idle modes, and the actions taken within an idle mode, may vary without altering the benefit of a forced idle cache.

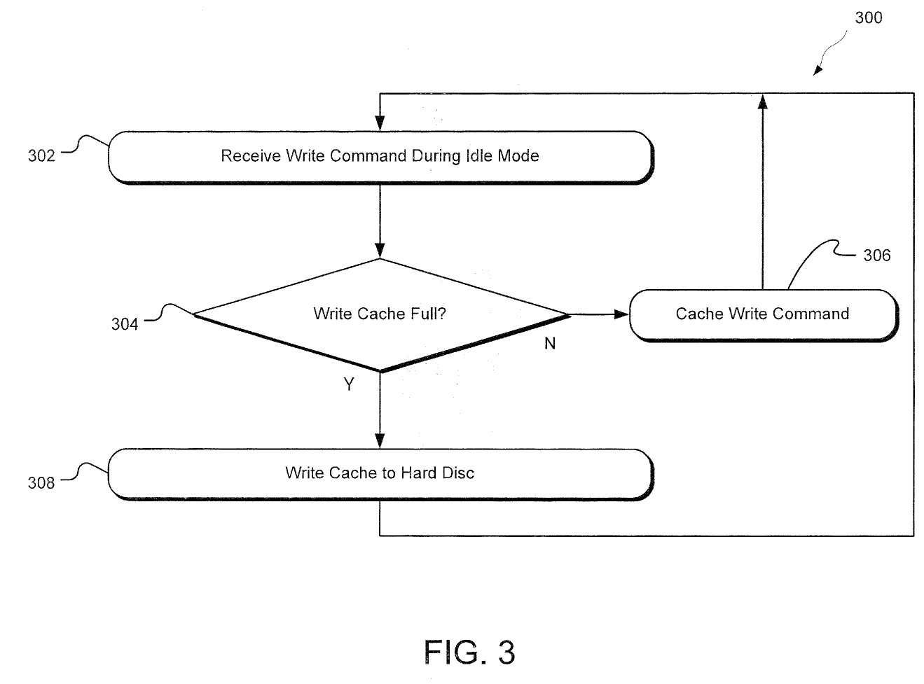

FIG. 3 illustrates example operations for forcing an idle cache. When caching is enabled, a storage device may cache the data, assuming there is sufficient available storage space in the write cache, from write commands during idle modes. Since disc access (i.e., data read from or written to persistent storage) is limited during an idle mode, power consumption of a storage device is reduced. In a receive operation 302, a write command is received during an idle mode. In a determination operation 304, a determination is made as to whether the cache is full. In one implementation, the write cache is full if the amount of data stored in the write cache is substantially equal to the total size of the write cache. Additionally, the write cache may be full if the amount of data stored in the write cache and the amount of data from the write command would exceed the total size of the write cache. If the write cache is not yet full, a cache operation 306 places the data from the write command into the write cache. Alternatively, if the write cache is full, the data stored in the write cache, as well as the data from the write command are written to the hard disc in write operation 308. As a result, the data from write commands are continuously written to the write cache until the write cache is full. Once the write cache is full, all the data in the write cache is written to the disc.

It should be appreciated that other events can trigger data stored in the cache or buffer to be written to the disc. For example, data may be written to the disc, from the cache, during a transition between idle modes and a non-cached read command (e.g., a read request for data that is not currently stored in a read cache.) Further, it should be appreciated that an interface controller or other components of a storage device may be used to implement forced idle caching. Additionally, hardware, firmware, software, or a combination thereof may be used to implement forced idle caching.

A cache or buffer containing data from previously issued commands is commonly referred to as a “dirty” cache or buffer. While use of a dirty buffer has a potential risk of losing data stored in the buffer, the advent of portable computers having batteries and battery backup systems significantly reduces the risk of data loss due to a dirty buffer. Portable computers and battery backup systems will generally enter a shutdown mode, forcing the cache or buffer to write to the disc, before the power supply is exhausted.

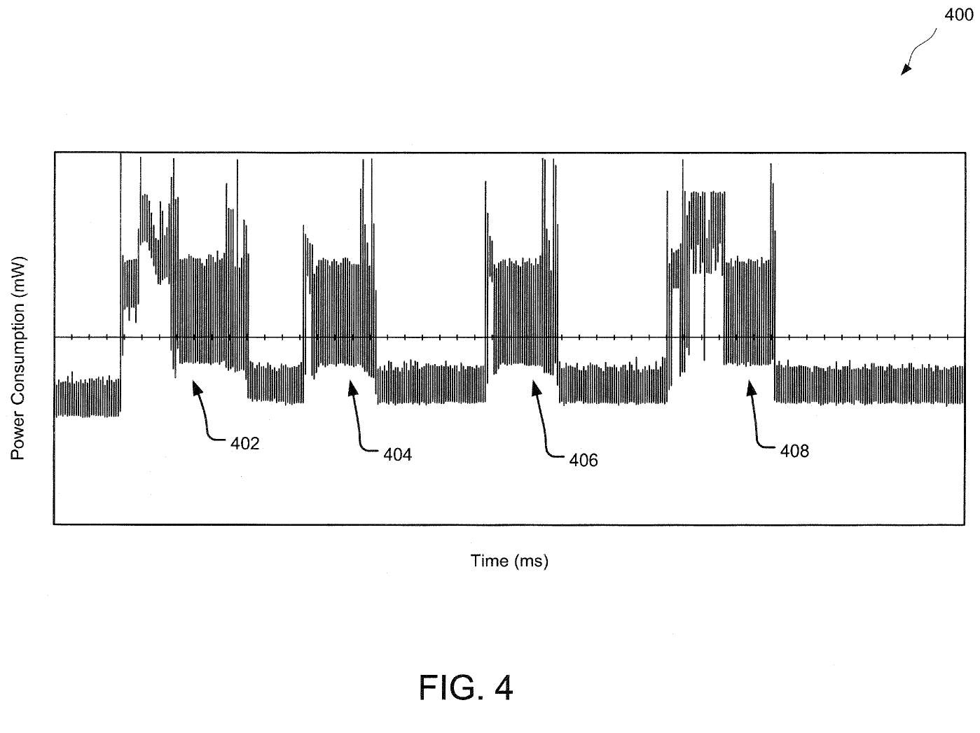

FIG. 4 illustrates an example power utilization profile for a storage device that does not utilize a forced idle cache. More specifically, FIG. 4 illustrates the power consumption of three random, small block writes 402, 404, and 406 followed by a random small block read 408 with an average delay of 400 milliseconds (ms) between each command. As shown in FIG. 4, this series of four commands results in four significant, extended increases in power consumption by the storage device. Without a forced idle cache, each command results in an independent access to the hard disc along with the increased power requirements for accessing the hard disc, four separate times.

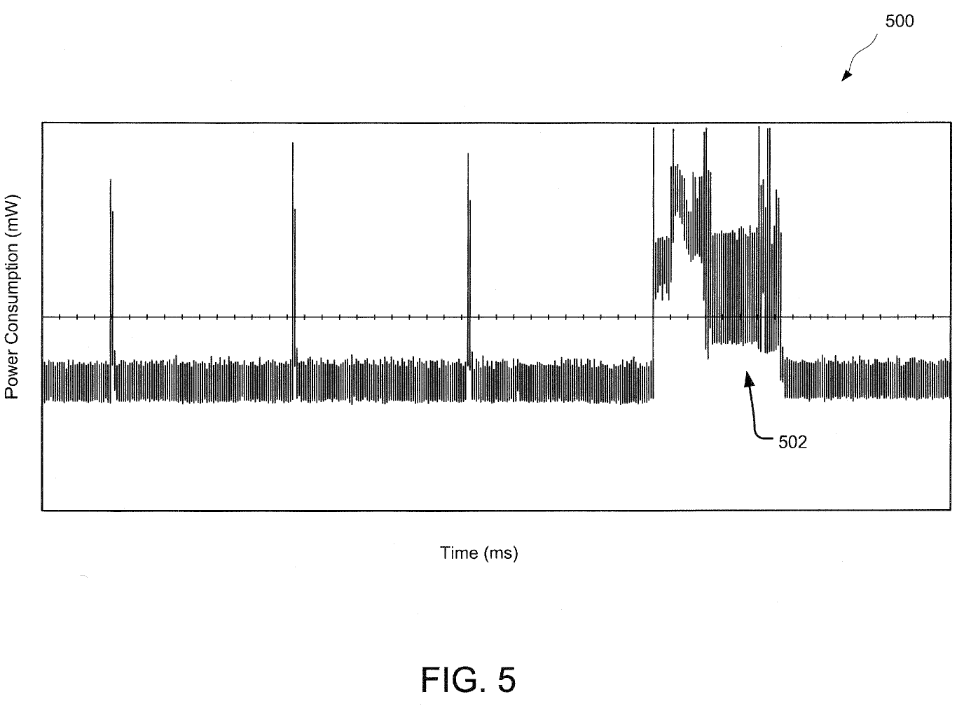

FIG. 5 illustrates an example power utilization profile for a storage device utilizing a forced idle cache. In contrast to the power utilization profile of FIG. 4, while the storage device receives the three small block write commands, the storage device remains in an idled cache mode until receipt of a non-cached read command 502 results in a disc access. When the read command is received and processed, the three cached write commands are also processed by writing data associated with the write commands to the disc. As such, the four independent commands were processed at one time, resulting in a decrease in power consumption from the storage device.

By increasing the amount of time the storage device remains in lower power modes, a reduction in power consumed by the storage device is realized. Comparing FIG. 5 to FIG. 4 shows that for the illustrated commands, a forced idle cache resulted in the storage device utilizing an Idle2 mode instead of a Performance Idle mode 21% of the available time. Additionally, the forced idle cache resulted in the storage device spending 64% of the available time in the Idle2 mode instead of the Idle1 mode. For the illustrated commands, the forced idle cache power profile of FIG. 5 represents a power savings of 275 mw, which is a savings of 10% over the traditional disc access commands illustrated in FIG. 4.

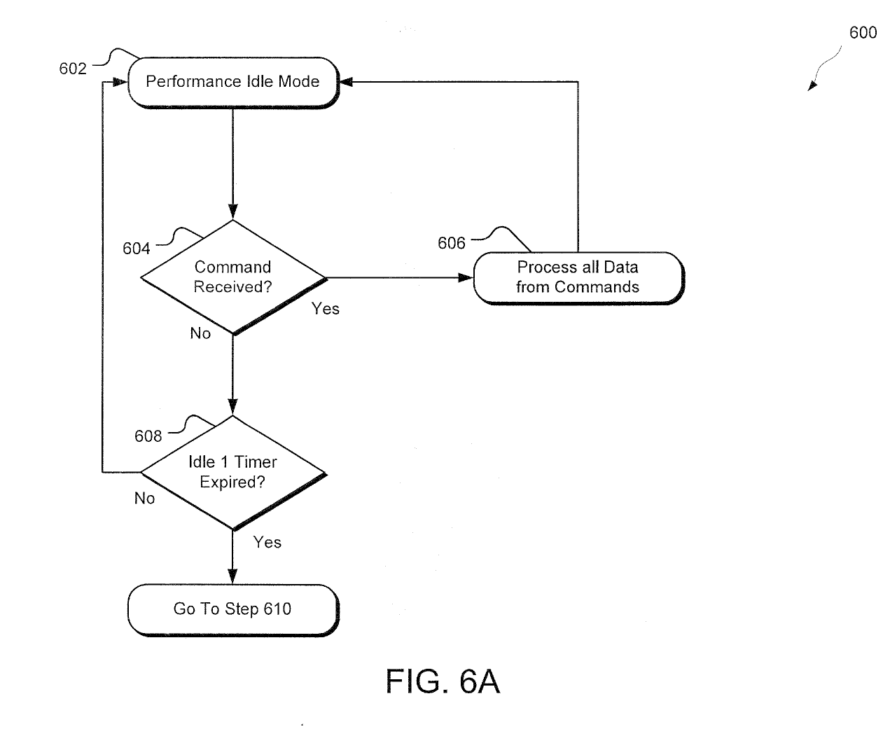

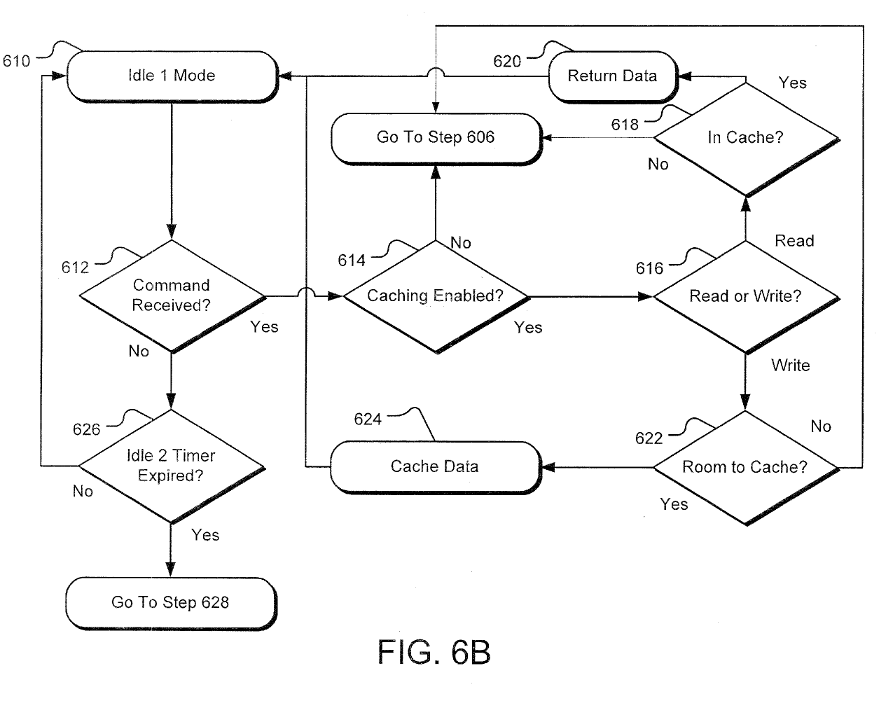

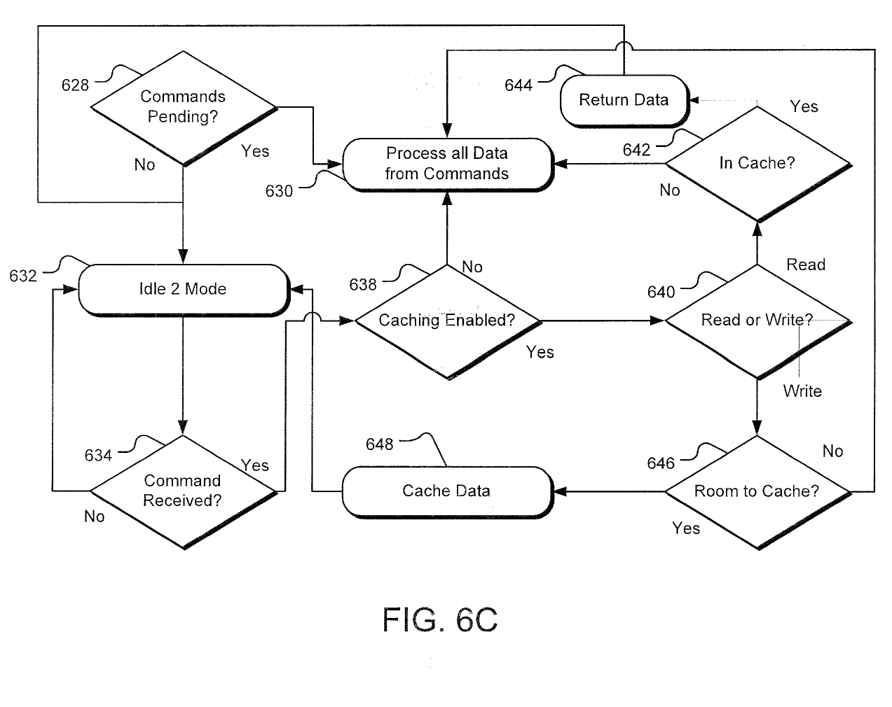

FIGS. 6A-6C illustrate example operations 600 for forcing an idle cache. In operation 602, a storage device is in a Performance Idle mode. In a determination operation 604, a determination is made as to whether a command is received from a CPU coupled to the storage device. In one implementation, a command may include a read command or a write command. If a read command is received, a processing operation 606 processes all the data associated with the received commands by writing the data temporarily stored in the write cache to a storage medium of the storage device, such as hard disc. In one implementation, all the data are processed because the amount of power to transition from Performance Idle mode to a disk access or active mode (e.g., read or write command) is insubstantial. Once all the data associated with the received commands are processed in operation 606, processing of the storage device returns to Performance Idle mode in operation 602. Alternatively, if a command is not received in operation 604, a determination operation 608 determines if an Idle 1 timer has expired. In one implementation, an Idle 1 timer is a pre-determined amount of time that the storage device remains in a Performance Idle mode if no commands are received. In one implementation, the Idle 1 timer is roughly 1-2 seconds. However, the Idle 1 timer, and other timers, may be dynamically configured to any amount of time. If the Idle 1 timer has not expired, processing of the storage device returns to operation 602 where the loop continues and the storage device remains in Performance Idle mode until the Idle 1 timer expires.

If the Idle 1 timer in operation 608 has expired, the storage device transitions to an Idle 1 mode in operation 610. As illustrated in FIG. 2 the Idle 1 mode consumes less power than the Performance Idle mode. Next, a determination operation 612 determines whether a command has been received from the CPU. If a command has been received in operation 612, a determination operation 614 determines if caching is enabled within the storage device. If caching is not enabled in the storage device, all data associated with the received commands are processed at operation 606, and processing of the storage device returns to the Performance Idle mode at operation 602. However, if determination operation 614 determines that caching is enabled, a determination operation 616 determines whether the received command is a read command or a write command. If the command is a read command, a determination operation 618 determines whether the data requested from the read command already exists in a read cache of the storage device. If the data exists in the read cache, an operation 620 returns the data to the CPU without accessing the disc. Further, the storage device remains in the Idle 1 mode and processing of the storage device returns to operation 610.

If determination operation 618 determines that the data requested from the read request is not in presently stored in the read cache, processing operation 606 processes the data associated with the read command by accessing the hard disc to retrieve the data. Further, any cached data associated with previously received write commands are also processed since the hard disc was accessed responsive to the non-cached read command. After the data associated with read and write commands are processed, the storage device transitions back to the Performance Idle mode and processing of the storage device returns to operation 602. The storage device transitions back to the Performance Idle mode because the read command resulted in disc access. While in Performance Idle mode, power consumption is higher than the Idle 1 mode. However, the spin-up or disc recovery time of the Performance Idle mode is faster as compared to Idle 1 mode. In one embodiment, spin-up or disc recovery time refers to the amount of time the disc spends returning to its full operating mode. In other words, if the hard disc is in a lower power state such as an Idle 1 mode, some components of the storage device are disabled or turned off as a means of reducing the power consumption of the storage device. However, the trade-off of reduced power consumption is the increased time to re-enable any disabled components.

Returning to determination operation 616, if the received command is a write command, a determination operation 622 determines if there is enough available space in the write cache to store the data associated with the write command. If there is enough space to cache the data from the write command, a store operation 624 stores the data in the write cache, with processing of the storage device returning to Idle 1 mode at operation 610. The storage device remains in Idle 1 mode since no disc access resulted from the write request. If determination operation 622 determines there is insufficient space to store the data associated with the write command, processing of the storage device returns to processing operation 606, where the data associated with the write command, and other cached data, is written to the disc. Once all of the write commands have been processed at processing operation 606, the storage device transitions back to the Performance Idle mode, with processing of the storage device returning to operation 602. The storage device transitions from a state having lower power consumption (e.g., Idle 1 mode) to a state having higher power consumption (e.g., Performance Idle mode) because a disc access resulted from the write command.

Returning to determination operation 612, if no commands are received, a determination operation 626 determines if an Idle 2 timer has expired. The Idle 2 timer is a pre-determined amount of time that the storage device remains in the Idle 1 mode if no commands are received that results in a disc access. In one implementation, the Idle 2 timer is roughly 8-30 seconds. However, the Idle 2 timer, and other timers, is dynamically configurable to any amount of time. If the Idle 2 timer has not expired, processing of the storage device returns to operation 610 where the storage device remains in Idle 1 mode until the Idle 2 timer expires.

Alternatively, if the Idle 2 timer has expired, a determination operation 628 determines if there are any pending commands to be processed. If there are any pending commands, processing operation 630 processes all the commands, which results in a disc access. Thus, the storage device transitions back to Performance Idle mode and processing of the storage device returns to operation 602. One reason for foregoing an Idle 2 mode when there are cached data associated with previously received commands may be for performance benefits. While the Idle 2 mode benefits from a lower power state than the Idle 1 mode, the Idle 2 mode also results in a slower spin-up or disc recovery time. As such, it may be beneficial to enter the Idle 2 mode if there are no cached commands. In one implementation, the Idle 2 timer may be dynamically set to any threshold, and may be user configurable.

If the determination operation 628 determines that no commands are pending, disc access is unnecessary, and the storage device transitions into the Idle 2 mode at operation 632. In one implementation, the Idle 2 mode consumes less power than the Idle 1 mode or the Performance Idle mode. A determination operation 634 determines if any commands have been received. If no commands are received, processing of the storage device returns to the Idle 2 mode at operation 632. The storage device remains in the Idle 2 mode until a command is received resulting in a disc access. When a command is received at determination operation 634, a determination operation 638 further determines whether caching of the storage device is enabled. If caching is not enabled, the processing operation 630 processes all data associated with the previously received commands. Because the processing of commands uses disc access, the storage device transitions back to the Performance Idle mode, and processing of the storage device returns to operation 602.

Alternatively, if determining operation 638 determines that caching is enabled, a determination operation 640 further determines whether the command received in operation 634 is a read command or a write command. If determination operation 640 determines that the received command is a read command, and a determination operation 642 determines that the data to be read already exists in the read cache, an operation 644 returns the data associated with read command to the CPU, from the read cache, without accessing the disc. The storage device remains in the Idle 2 mode, and processing of the storage device returns to operation 632. If determination operation 642 determines that the requested read data is not in the read cache, processing command 630 processes the read command, and other pending commands such as cached write commands. Because the processing of commands resulted in disc access, the storage device transitions back to Performance Idle mode, and processing of the storage device returns to operation 602.

Returning to operation 640, if the command received from operation 634 is a write command, a determination operation 646 determines whether the write cache has enough room to store the data associated with the write command. If determination operation 646 determines there is insufficient room in the write cache, processing operation 630 processes the data associated with the write command, and any other commands in the cache. Because the processing of commands resulted in disc access, the storage device transitions back to the Performance Idle mode, and processing of the storage device returns to operation 602. Alternatively, if there is sufficient space in the write cache to store the data from the write command, an operation 648 stores the data and processing of the storage device returns to and remains in the Idle 2 mode at operation 632. The storage device remains in the Idle 2 mode since disc access was not needed to place the data from the write command into the write cache. The storage device remains in the Idle 2 mode until a command is received that results in disc access or until the write cache becomes full.

While FIG. 6 is described with respect to specific modes, it should be appreciated that when an amount of time expires without disc access, a storage device may move to a mode consuming less power. Similarly, if disc access results from a received command, the storage device transitions to a higher power state. Additionally, the ordering of operations illustrated in FIG. 6 is merely an example. Any deviation from the ordering of the operations does not affect the scope of a storage device forcing an idle cache mode. Further, some of the operations illustrated in FIG. 6 may also be optional.

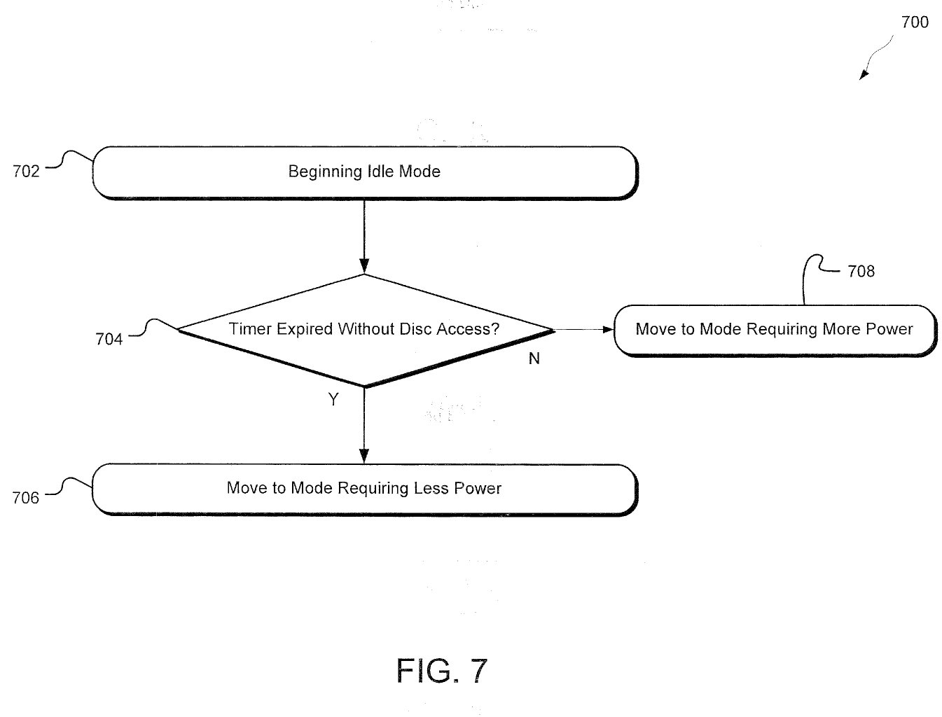

FIG. 7 illustrates example storage device operation modes 700 for conservation of power. In operation 702, a storage device begins in an idle mode. If a timer in operation 704 expires without the need for disc access, operation 706 will transition the storage device to a mode that consumes less power, such as an Idle 1 or Idle 2 mode. If disc access is needed before the timer in operation 704 expires, than operation 708 will transition the storage device to a mode using more power, such as Performance Idle mode. If disc access is infrequent, the drive may conserve a considerable amount of power.

In another implementation, a hybrid storage device may also benefit from a forced idle cache. A hybrid storage device may be a storage device that utilizes both a platter-based disc array as well as a secondary flash-based storage medium. As with a cache, a flash-based storage medium can be accessed without the slower mechanical components used to access a hard disc. As a result, data can be read from and written to the medium faster and with less power consumption than a hard disc. An additional benefit to a flash-based storage medium is that the memory is non-volatile, so the data is persistently stored. Thus, the medium maintains the data even after power supplied to the storage device is lost.

In another implementation, a hybrid drive may also use a volatile cache or buffer as described through the specification. In other words, the drive may utilize a platter-based disc array, a flash-based storage medium, and a volatile cache. In one implementation, including a flash-based storage medium allows for additional cache storage of both read and write data. In other words, once the read and/or write cache becomes full, additional data from received write commands may be stored in the flash-based storage medium. As such, it may be possible to postpone disc access by maintaining the storage device in an idle mode for a longer period as compared to hard discs that do not utilize a force idle cache. In another implementation, a larger amount of cached read data may also be stored in either the cache and/or the flash-based storage medium. By expanding the amount of read data that may be stored outside of the hard disc, the storage device may remain in a forced idle mode for a longer period, thus increasing the benefits of reduced power consumption. Additionally, with a flash-based storage medium, the read data stored in the medium may persistently exist even after power to the storage device has been lost. Therefore, frequently accessed read data does not have to be moved back to the flash-based medium once the storage device reboots. Further, write data stored in the flash-based storage medium is also persistently stored. In the event of an unexpected power failure, any data associated with a received write command can be recovered and written to the hard disc after the power failure.

While specific modes of storage device operation are disclosed herein, it should be understood that a storage device may reduce power consumption by transitioning to any lower power mode when disc access is unnecessary.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. It should be understood that logical operations may be performed in any order, unless explicitly claimed otherwise or a specific order is inherently necessitated by the claim language. Furthermore, it should be appreciated that the logical steps disclosed herein may be stored on any computer readable storage medium.

The above specification, examples, and data provide a complete description of the structure and use of example embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method for reducing power consumption of an electronic device, comprising:
caching data associated with write commands received while the electronic device is in an idle mode.

2. A method according to claim 1, further comprising:
flushing the data associated with the write commands from a write cache to a storage medium when the write cache is full.

3. A method according to claim 1, further comprising:
flushing the data associated with the write commands from a write cache to a storage medium when an idle transition occurs.

4. A method according to claim 1, further comprising:
flushing the data associated with the write commands from a write cache to a storage medium when a non-cached read request is received.

5. A method according to claim 1, further comprising:
transitioning the electronic device to a lower power mode when disc access is not required.

6. A method according to claim 1, further comprising:
receiving a command; and
transitioning the electronic device to a higher power mode when the received command results in disc access.

7. A method according to claim 1, further comprising:
transitioning the electronic device to a lower power mode when at least one of (1) a write cache is empty and (2) an idle timer is expired.

8. A method according to claim 7, further comprising:
disabling one or more components of the electronic device when the electronic device transitions to the lower power mode.

9. A method according to claim 1, further comprising:
reordering at least a portion of the received write commands before the data associated with the write commands are written to a electronic device.

10. An electronic device comprising an interface controller configured to cache data associated with received write commands to a write cache while the electronic device is in an idle mode and the write cache is not full.

11. The electronic device of claim 10, wherein the interface controller is further configured to write data associated with received write commands to a storage medium when the write cache is full.

12. The electronic device of claim 10, wherein the interface controller is further configured to write data associated with received write commands to a storage medium when a non-cached read command is received.

13. The electronic device of claim 10, wherein the interface controller is further configured to transition the electronic device to a lower power mode when at least one of (1) an idle timer is expired and (2) disc access is not required.

14. The electronic device of claim 10, wherein the interface controller is further configured to transition the electronic device to a higher power mode when disc access is required.

15. The electronic device of claim 13, wherein the interface controller is further configured to disable one or more components of the electronic device when the electronic device transitions to the lower power mode.

16. A method of reducing power consumption of an electronic device, comprising:
transitioning the electronic device to a performance idle mode if a received command requires disc access;
transitioning the electronic device to a first idle mode if at least one of (1) a first idle timer is expired and (2) disc access is not required, wherein the first idle mode has a lower power consumption than the performance idle mode; and
transitioning the electronic device to a second idle mode if at least one of (1) a second idle timer is expired and (2) no disc access is required, wherein the second idle mode has a lower power consumption than the first idle mode.

17. The method of claim 16, further comprising:
caching data associated with received write commands to a write cache if the electronic device is not in the performance idle mode and the write cache is not full.

18. The method of claim 16, wherein transitioning the electronic device to the performance idle mode further comprises:
flushing data associated with received write commands from a write cache to a storage medium.

19. The method of claim 16, further comprising:
transitioning the electronic device to the performance idle mode if a non-cached read command is received.

20. The method of claim 16, further comprising:
transitioning the electronic device to the performance idle mode if a write command is received and a write cache is full.
